(19) United States
(12) Patent Application Publication
(10) Pub. No.: US 2012/0047339 A1
(43) Pub. Date: Feb. 23, 2012

(54) REDUNDANT ARRAY OF INDEPENDENT CLOUDS

(76) Inventors: Dan Decasper, Sunnyvale, CA (US); Allen Samuels, San Jose, CA (US); Jonathan Stone, San Carlos, CA (US)

(21) Appl. No.: 12/860,810

(22) Filed: Aug. 20, 2010

(51) Int. Cl. G06F 12/00; G06F 12/02; G06F 12/16; G06F 12/14

(52) U.S. Cl. 711/162; 713/193; 711/173; 711/E12.001; 711/E12.002

(57) ABSTRACT

A computing device executing a reliable cloud storage module divides data into a first data block and a second data block. The computing device stores the first data block in a first storage cloud provided by a first storage service, and stores the second data block in a second storage cloud provided by a second storage service. The computing device thereafter receives a command to read the data. In response, the computing device retrieves the first data block from the first storage cloud and the second data block from the second storage cloud. The computing device then reproduces the original data from the first data block and the second data block.

### TECHNICAL FIELD

Embodiments of the present invention relate to data storage, and more specifically to a method and apparatus for storing data in a redundant array of independent clouds.

### BACKGROUND

Enterprises typically include expensive collections of network storage, including storage area network (SAN) products and network attached storage (NAS) products. As an enterprise grows, the amount of storage that the enterprise must maintain also grows. Thus, enterprises are continually purchasing new storage equipment to meet their growing storage needs. However, such storage equipment is typically very costly. Moreover, an enterprise has to predict how much storage capacity will be needed, and plan accordingly.

Cloud storage has recently developed as a storage option. Cloud storage is a service in which storage resources are provided on an as needed basis, typically over the internet. With cloud storage, a purchaser only pays for the amount of storage that is actually used. Therefore, the purchaser does not have to predict how much storage capacity is necessary. Nor does the purchaser need to make up front capital expenditures for new network storage devices. Thus, cloud storage is typically much cheaper than purchasing network devices and setting up network storage.

Despite the advantages of cloud storage, enterprises are reluctant to adopt cloud storage as a replacement to their network storage systems due to its disadvantages. First, most cloud storage uses completely different semantics and protocols than have been developed for file systems. For example, network storage protocols include common internet file system (CIFS) and network file system (NFS), while protocols used for cloud storage include hypertext transport protocol (HTTP) and simple object access protocol (SOAP). Additionally, cloud storage does not provide any file locking operations, nor does it guarantee immediate consistency between different file versions. Therefore, multiple copies of a file may reside in the cloud, and clients may unknowingly receive old copies. Additionally, storing data to and reading data from the cloud is typically considerably slower than reading from and writing to a local network storage device.

Cloud storage protocols also have different semantics to block-oriented storage, whether network block-storage like internet small computer system interface (iSCSI), or conventional block-storage (e.g., SAN, direct-attached storage (DAS), etc.). Block-storage devices provide atomic reads or writes of a contiguous linear range of fixed-sized blocks. Each such write happens “atomically” with request to subsequent read or write requests. Allowable block ranges for a single block-storage command range from one block up to several thousand blocks. In contrast, cloud-storage objects must each be written or read individually, with no guarantees, or at best weak guarantees, of consistency of subsequent read requests which read some or all of a sequence of writes to cloud-storage objects.

In standard storage solutions (e.g., NAS and SAN), storage devices are often arranged into a redundant array of independent disks (RAID) for performance and/or reliability improvement. However, there is presently no equivalent to RAID technologies for cloud storage. Embodiments of the present invention combine the advantages of network storage devices and the advantages of cloud storage while mitigating the disadvantages of both.

### SUMMARY

Described herein are a method and apparatus for storing data in a redundant array of independent storage clouds. In one embodiment, a computing device executing a reliable cloud storage module divides data into multiple data blocks. The computing device stores first data blocks in a first storage cloud provided by a first storage service, and stores second data blocks in a second storage cloud provided by a second storage service. In one embodiment, the computing device generates parity blocks, which the computing device may store in a third storage cloud provided by a third storage service. Each of the storage services may be web-based storage services, such as, for example, but not limited to, Amazon's Simple Storage Service (S3), Iron Mountain's cloud storage and Rackspace's Cloudfiles. The computing device thereafter receives a command to read the data. In response, the computing device retrieves the first data block from the first storage cloud and the second data block from the second storage cloud. The computing device then reproduces the original data from the first data block and the second data block. If either the first storage cloud or the second storage cloud is unavailable, the computing device retrieves the parity block from the third storage cloud and recreates the missing data block from the retrieved data block and the parity block. More or fewer than two storage clouds may be used to store data blocks in alternative embodiments.

### BRIEF DESCRIPTION OF THE DRAWINGS

The present invention is illustrated by way of example, and not by way of limitation, in the figures of the accompanying drawings and in which:

FIG. 1 illustrates an exemplary network architecture, in which embodiments of the present invention may operate;

FIG. 2 illustrates a block diagram of a reliable cloud storage module, in accordance with one embodiment of the present invention;

FIG. 3A is a flow diagram illustrating one embodiment of a method for storing data in a redundant array of independent clouds;

FIG. 3B is a flow diagram illustrating another embodiment of a method for storing data in a redundant array of independent clouds;

FIG. 4A is a block diagram illustrating an example of storing data in a redundant array of independent clouds, in accordance with one embodiment of the present invention;

FIG. 4B is a block diagram illustrating an example of storing data in a redundant array of independent clouds, in accordance with another embodiment of the present invention;

FIG. 5A is a flow diagram illustrating one embodiment of a method for retrieving data from a redundant array of independent clouds;

FIG. 5B is a flow diagram illustrating another embodiment of a method for retrieving data from a redundant array of independent clouds;

FIG. 6A is a block diagram illustrating an example of retrieving data from a redundant array of independent clouds, in accordance with one embodiment of the present invention;

FIG. 6B is a block diagram illustrating an example of retrieving data from a redundant array of independent clouds, in accordance with another embodiment of the present invention;

FIG. 7 is a flow diagram illustrating one embodiment of a method for rebuilding data from a failed storage cloud;

FIG. 8A is a block diagram illustrating an example of reconstructing data stored on a failed storage cloud, in accordance with one embodiment of the present invention;

FIG. 8B is a block diagram illustrating an example of reconstructing data stored on a failed storage cloud, in accordance with another embodiment of the present invention;

FIG. 9 illustrates a diagrammatic representation of a machine in the exemplary form of a computer system within which a set of instructions, for causing the machine to perform any one or more of the methodologies discussed herein, may be executed.

### DETAILED DESCRIPTION

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “dividing”, “storing”, “retrieving”, “reproducing”, “encrypting”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The present invention may be provided as a computer program product, or software, that may include a machine-readable medium having stored thereon instructions, which may be used to program a computer system (or other electronic devices) to perform a process according to the present invention. A machine-readable medium includes any mechanism for storing information in a form readable by a machine (e.g., a computer). For example, a machine-readable (e.g., computer-readable) medium includes a machine readable storage medium such as a read only memory (“ROM”), random access memory (“RAM”), magnetic disk storage media, optical storage media, flash memory devices, etc.

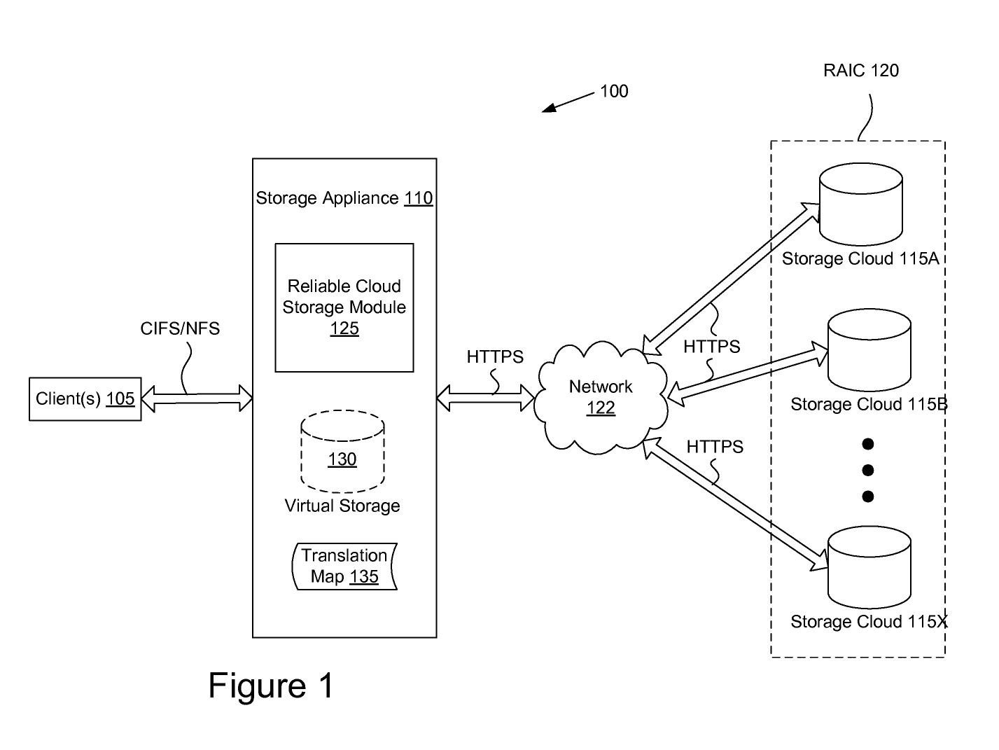

FIG. 1 illustrates an exemplary network architecture 100, in which embodiments of the present invention may operate. The network architecture 100 includes one or more clients 105 connected to a storage appliance 110. The clients 105 may be connected to the storage appliance 110 directly or via a local network (not shown). The network architecture 100 further includes the storage appliance 110 connected to multiple storage clouds 115 via a network 122, which may be a public network, such as the Internet, a private network, such as a wide area network (WAN), or a combination thereof.

Each of the storage clouds 115A, 115B though 115X is a dynamically scalable storage provided as a service over a public network (e.g., the Internet) or a private network (e.g., a wide area network (WAN). Some examples of storage clouds include Amazon's® Simple Storage Service (S3), Nirvanix® Storage Delivery Network (SDN), Windows® Live SkyDrive, Ironmountain's® storage cloud, Rackspace® Cloudfiles, AT&T® Synaptic Storage as a Service, Zetta® Enterprise Cloud Storage On Demand, IBM® Smart Business Storage Cloud, and Mosso® Cloud Files. Most storage clouds provide unlimited storage through a simple web services interface (e.g., using standard HTTP commands or SOAP commands). However, most storage clouds 115 are not capable of being interfaced using standard file system protocols such as common internet file system (CIFS), direct access file systems (DAFS), block-level network storage devices such as the Internet small computer systems interface (iSCSI), or network file system (NFS). The storage clouds 115 are object based stores. Data objects stored in the storage clouds 115 may have any size, ranging from a few bytes to the upper size limit allowed by the storage cloud (e.g., 5 GB).

In one embodiment, each of the clients 105 is a standard computing device that is configured to access and store data on network storage. Each client 105 includes a physical hardware platform on which an operating system runs. Examples of clients 105 include desktop computers, laptop computers, tablet computers, netbooks, mobile phones, etc. Different clients 105 may use the same or different operating systems. Examples of operating systems that may run on the clients 105 include various versions of Windows, Mac OS X, Linux, Unix, O/S 2, etc.

Storage appliance 110 may be a computing device such as a desktop computer, rackmount server, etc. Storage appliance 110 may also be a special purpose computing device that includes a processor, memory, storage, and other hardware components, and that is configured to present storage clouds 115 to clients 105 as though the storage clouds 115 were standard network storage devices. In one embodiment, storage appliance 110 is a cluster of computing devices. Storage appliance 110 may include an operating system, such as Windows, Mac OS X, Linux, Unix, O/S 2, etc. Storage appliance 110 may further include a reliable cloud storage module (RCSM) 125, virtual storage 130 and translation map 135. In one embodiment, the storage appliance 110 is a client that runs a software application including the cloud storage module (RCSM) 125, virtual storage 130 and translation map 135.

In one embodiment, clients 105 connect to the storage appliance 110 via standard file systems protocols, such as CIFS or NFS. The storage appliance 110 communicates with the client 105 using CIFS commands, NFS commands, server message block (SMB) commands and/or other file system protocol commands that may be sent using, for example, the internet small computer system interface (iSCSI) or fiber channel. NFS and CIFS allow files to be shared transparently between machines (e.g., servers, desktops, laptops, etc.). Both are client/server applications that allow a client to view, store and update files on a remote storage as though the files were on the client's local storage.

The storage appliance 110 communicates with the storage clouds 115 using cloud storage protocols such as hypertext transfer protocol (HTTP), hypertext transport protocol over secure socket layer (HTTPS), simple object access protocol (SOAP), representational state transfer (REST), etc. Thus, storage appliance 110 may store data in storage clouds using, for example, common HTTP POST or PUT commands, and may retrieve data using HTTP GET commands. Storage appliance 110 may communicate with different storage clouds using different cloud storage protocols. These may be dictated by storage service providers. For example, storage appliance 110 may communicate with storage cloud 115A using HTTPS and may communicate with storage cloud 115B using SOAP. Additionally, even for storage clouds that use the same cloud storage protocols, those storage clouds may require different message formatting and/or message contents. Storage appliance 110 formats each message so that it will be correctly interpreted and acted upon by the particular storage cloud to which that message is directed.

In a conventional network storage architecture, clients 105 would be connected directly to storage devices, or to a local network (not shown) that includes attached storage devices (and possibly a storage server that provides access to those storage devices). In contrast, the illustrated network architecture 100 does not include any network storage devices attached to a local network. Rather, in one embodiment of the present invention, the clients 105 store all data on the storage clouds 115 via storage appliance 110 as though the storage clouds 115 were network storage of the conventional type.

The storage appliance emulates a file system stack that is understood by the clients 105, which enables clients 105 to store data to the storage clouds 115 using standard file system semantics (e.g., CIFS or NFS). Therefore, the storage appliance 110 can provide a functional equivalent to traditional file system servers, and thus eliminate any need for traditional file system servers. In one embodiment, the storage appliance 110 provides a cloud storage optimized file system that sits between an existing file system stack of a conventional file system protocol (e.g., NFS or CIFS) and physical storage that includes the storage clouds 115.

In one embodiment, the storage appliance 110 includes a virtual storage 130 that is accessible to the client 105 via the file system protocol commands (e.g., via NFS or CIFS commands). The virtual storage 130 may be, for example, a virtual file system or a virtual block device. The virtual storage 130 appears to the client 105 as an actual storage, and thus includes the names of data (e.g., file names or block names) that client 105 uses to identify the data. For example, if client 105 wants a file called newfile.doc, the client 105 requests newfile.doc from the virtual storage 130 using a CIFS or NFS read command. By presenting the virtual storage 130 to client 105 as though it were a physical storage, storage appliance 110 may act as a storage proxy for client 105. In one embodiment, the virtual storage 130 is accessible to the client 105 via block-level commands (e.g., via iSCSI commands. In this embodiment, the storage 130 is represented as a storage pool, which may include one or more volumes, each of which may include one or more logical units (LUNs).

In one embodiment, the storage appliance 110 includes a translation map 135 that maps the names of the data (e.g., file names or block names) that are used by the client 105 into the names of data objects (e.g., data blocks and/or parity blocks) that are stored in the storage clouds 115. The data objects may each be identified by a permanent globally unique identifier. Therefore, the storage appliance 110 can use the translation map 135 to retrieve data objects from the storage clouds 115 in response to a request from client 105 for data included in a LUN, volume or pool of the virtual storage 130.

The storage appliance may also include a local cache (not shown) that contains a subset of data stored in the storage clouds 115. The cache may include, for example, data that has recently been accessed by one or more clients 105 that are serviced by storage appliance 110. The cache may also contain data that has not yet been written to the storage clouds 115. Upon receiving a request to access data, storage appliance 110 can check the contents of the cache before requesting data from the storage clouds 115. That data that is already stored in the cache does not need to be obtained from the storage clouds 115.

In one embodiment, when a client 105 attempts to read data, the client 105 sends the storage appliance 110 a name of the data (e.g., as represented in the virtual storage 130). The storage appliance 110 determines the most current version of the data and a location or locations for the most current version in the storage clouds 115 (e.g., using the translation map 135). The storage appliance 110 then obtains the data from the storage clouds 115.

Once the data is obtained, it may be decompressed and decrypted by the storage appliance 110, and then provided to the client 105. Additionally, the data may have been subdivided into multiple data blocks that were distributed between multiple storage clouds. The storage appliance 110 may combine the multiple data blocks to reconstruct the requested data. To the client 105, the data is accessed using a file system protocol (e.g., CIFS or NFS) as though it were uncompressed clear text data on local network storage. It should be noted, though, that the data may still be separately encrypted over the wire by the file system protocol that the client 105 used to access the data.

Similarly, when a client 105 attempts to store data, the data is first sent to the storage appliance 110. The storage appliance 110 may then divide the data into multiple data blocks, generate parity blocks from the data blocks, and compress and/or encrypt the data blocks. The storage appliance 110 may then write the data blocks and/or parity blocks to the storage clouds 115 using the protocols understood by the storage clouds 115.

The reliable cloud storage module (RCSM) 125 generates a redundant array of independent clouds (RAIC) from two or more storage clouds 115. The RCSM 125 can present the RAIC 120 to clients 105 as a single storage device (e.g., via virtual storage 130). In one embodiment, RAIC 120 is configured to store data for a particular volume of a storage pool. Alternatively, RAIC 120 may be configured to store data for an entire pool (e.g., for the entire virtual storage 130). Since the amount of data that can be stored on each storage cloud 115 has no upper bound, the virtual storage 130 may have an arbitrarily large storage capacity, which may be adjusted by an administrator.

In one embodiment, to implement the RAIC 120, the RCSM 125 treats each storage cloud 115 as an independent disk, and may apply standard redundant array of inexpensive disks (RAID) modes to the storage clouds 115. For example, RCSM 125 may set up the RAIC 120 in a RAID 0 mode (or an equivalent of the RAID 0 mode), in which data is striped across multiple storage clouds 115, or in a RAID 1 mode (or an equivalent of the RAID 1 mode), in which data is mirrored across multiple storage clouds 115. When storage clouds 115 are arranged into a RAIC 120, the RCSM 125 determines which storage cloud 115 within the RAIC 120 individual portions of data should be stored. The reliable cloud storage module 125 may divide and replicate data among the multiple storage clouds 115 according to a specified redundant array of independent disks (RAID) mode.

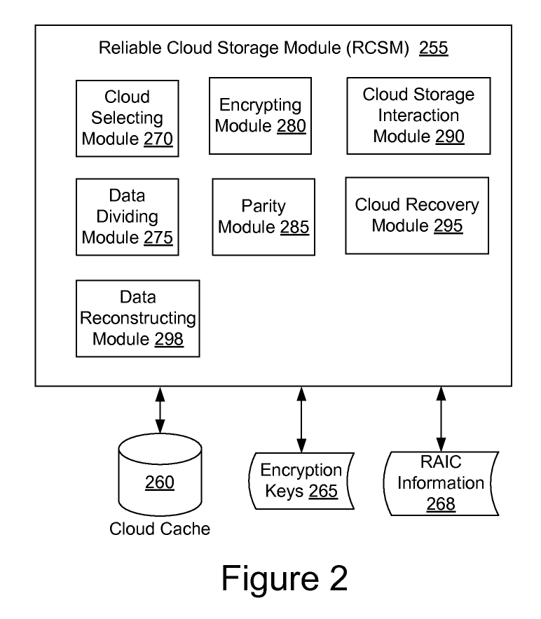

FIG. 2 illustrates a block diagram of a reliable cloud storage module (RCSM) 255, which may correspond to RCSM 125 of FIG. 1. RCSM 255 combines two or more storage clouds into a redundant array of independent clouds. In one embodiment, RCSM 255 includes a cloud selecting module 270, a data dividing module 275, an encrypting module 280, a parity module 285, a cloud storage interaction module 290 and a cloud recovery module 295. Alternatively, the RCSM 255 may include more modules (where the functionality of one or more illustrated modules is divided between multiple modules) or fewer modules (where the functionality of illustrated modules are combined into a single module).

When the RCSM 255 receives a request to store data, data dividing module 275 divides that data into multiple data blocks. The data to be stored may be a single file, a collection of files that have been combined into a single data object, a compressed file or group of files, or other type of data. The size of the data blocks may be fixed or variable. The size of the data blocks may be chosen based on how frequently a file is written (e.g., frequency of rewrite), cost per operation charged by cloud storage provider, etc. If cost per operation was free, the size of the data blocks would be set very small. This would generate many I/O requests. Since storage cloud providers charge per I/O operation, very small data block sizes are therefore not desirable. Moreover, storage providers round the size of data objects up. For example, if 1 byte is stored, a client may be charged for a kilobyte. Therefore, there is an additional cost disadvantage to setting a data blocks size that is smaller than the minimum object size used by the storage clouds.

There is also overhead time associated with setting the operations up for a read or a write. Typically, about the same amount of overhead time is required regardless of the size of the data blocks. Therefore, data divided into larger data blocks will have fewer data blocks, which will in turn require fewer read and fewer write operations. Therefore, for small data blocks the setup cost dominates, and for large data blocks the setup cost is only a small fraction of the total cost spent obtaining the data.

These competing concerns should be considered in choosing the data block sizes. In one embodiment, data blocks have a size on the order of one or a few megabytes. In another embodiment, data block sizes range from 64 Kb to 10 Mb. In one embodiment, the useful data block sizes vary depending on the operational characteristics of the network and cloud storage subsystems. Thus as the capabilities of these systems increase the useful data block sizes could similarly increase to avoid having setup times limit overall performance. In one embodiment, when data is divided into multiple data blocks, each of those data blocks into which the data is divided is identically sized. This enables certain parity functions to be used on the data blocks.

Cloud selecting module 270 determines which storage clouds each data block should be stored in. In one embodiment, cloud selecting module 270 uses RAIC information 268 to determine which storage clouds on which to store the data blocks. The RAIC information 268 may identify a RAIC associated with a particular pool, volume or LUN. The RAIC information 268 may further identify properties of the RAIC, such as a RAID mode that is being used, the number of storage clouds in the RAIC, and which storage clouds are included in the RAIC.

The RCSM 255 may use multiple different RAID modes for storing data in the storage clouds. There are three distinct data management techniques used in RAID: striping (dividing data across multiple storage devices), error correction (using parity (redundant data) to enable detection and correction of data loss) and mirroring (writing identical data to multiple storage devices). Some examples of RAID modes that may be used for the RAIC are described below. However, it should be understood that versions of any conventional RAID mode may be used with the RAIC. Additionally, nested RAID modes may also be used with the RAIC.

For the RAID 0 mode, data dividing module 275 divides data into multiple data blocks, which get stored to different storage clouds. No parity blocks are generated for the RAID 0 mode. To retrieve the original data, each of the data blocks needs to be retrieved. For standard RAID, the RAID 0 mode is very risky, because if any disk in the RAID fails, data on all disks is lost. However, the RAID 0 mode as used with the RAIC poses little risk, because each storage cloud includes built in backups, and the chance of any storage cloud losing data is extremely low.

For the RAID 1 mode, each data block generated by the data dividing module is written to at least two storage clouds. The data may be written to the different storage clouds in parallel or quasi-parallel (e.g., simultaneous connections may be established with each storage cloud, and the data blocks may be uploaded to the storage clouds concurrently). In RAID 1 mode, no parity blocks are generated. Since duplicates of the data blocks are stored to multiple storage clouds, no parity is necessary. If one storage cloud becomes unavailable, the data can still be retrieved from the other storage cloud (or storage clouds).

In addition to providing increased data reliability, using the RAIC in RAID 1 mode can also provide improved performance. Bandwidth, network traffic, latency, etc. may be different for connections between the storage appliance and a first storage cloud and between the storage appliance and a second storage cloud. When the storage appliance receives a read command from a client, the RCSM 255 may determine from which storage cloud the data can be most quickly retrieved, and may then retrieve the data from that storage cloud. As network conditions change, the determination of from which storage cloud to retrieve data may also change.

In one embodiment, when the RAIC is used in a RAID 1 mode, the RCSM 255 determines which storage cloud or clouds to retrieve data from upon receiving a read command. The determination of which storage clouds to retrieve data from may be based on a user-configured policy. User configured policies may specify, for example, to retrieve data from particular storage clouds based on time of day, size of data requested to be read, total data transferred from each storage cloud, latency to each storage cloud, storage cloud cost parameters, etc.

For the RAID 3 mode, data dividing module 275 divides data into multiple data blocks, which are then stored across multiple different storage clouds (performs striping). Additionally, parity module 285 generates a parity block from a combination of the multiple data blocks. Different algorithms may be used for generating the parity block. The most common algorithm is to perform a Boolean XOR operation using all of the data blocks. The parity block then gets stored on a storage cloud that is dedicated to storing only parity blocks. The RAID 3 mode requires a minimum of three storage clouds: two storage clouds for storing the data blocks and one storage cloud for storing the parity blocks. As the number of storage clouds included in the RAIC increases, storage efficiency is increased because a lower percentage of storage space is dedicated to the parity blocks.

The RAID 5 mode is similar to the RAID 3 mode, except that the parity blocks are distributed across all storage clouds. For example, for first data, the parity block may be stored on a first storage cloud, and for second data, the parity block may be stored on a second storage cloud. For the RAID 6 mode, at least four storage clouds are needed. In the RAID 6 mode, two parity blocks are generated from the data blocks. Therefore, two storage clouds need to fail before data becomes unrecoverable.

The RCSM 255 may also apply a nested RAID scheme to a managed RAIC. For example, the RCSM 255 may use a RAID 0+1 mode or a RAID 1+0 mode. In the RAID 1+0 mode, data is mirrored between storage clouds, and then striped across additional storage clouds. The RAID 1+0 mode requires a minimum of four storage clouds. In the RAID 0+1 mode, data is striped across multiple storage clouds, and then mirrored onto additional storage clouds. The RAID 0+1 mode also requires a minimum of four storage clouds.

If a RAID mode is used that requires generation of a parity block, parity module 285 generates a parity block from a combination of the data blocks. In one embodiment, the parity module 285 performs an XOR operation using each of the data blocks to generate the parity block. In such an embodiment, each of the data blocks into which the data has been divided should have the same size. The generated parity block then has a size that is equal to the size of the data blocks. Parity module 285 may return the parity block to the cloud selecting module 270, which may assign a storage cloud to the parity block. In some RAID modes (e.g., RAID 3 mode), parity blocks are always stored on the same storage cloud. The storage cloud that is dedicated to storing parity blocks may be a storage cloud whose cost structure makes the storage of parity blocks cheaper than if they were stored on other storage clouds. In other RAID modes (e.g., RAID 5 mode), parity blocks may be stored on any storage cloud included in the RAIC.

In one embodiment, the data blocks and/or parity blocks are encrypted by encrypting module 280. Encrypting module 280 may use standard cryptographic techniques to encrypt the data blocks and/or parity blocks. For example, the encrypting module 280 may encrypt data blocks and/or parity blocks using an encryption algorithm such as a block cipher. In one embodiment, a block cipher is used in a mode of operation such as cipher-block chaining, cipher feedback, output feedback, etc.

Encrypting module 280 encrypts the data blocks and/or parity blocks using one or more globally agreed upon sets of encryption keys 265. The encryption keys 265 are linked to accounts on the storage clouds. The accounts in turn may be linked to particular storage pools represented in virtual storage. In one embodiment, a different set of keys 265 is associated with each storage cloud. Alternatively, two or more storage clouds may share a single set of keys 265. Encrypting module 280 may encrypt each data block using the set of keys 265 associated with the storage cloud on which that data block will be stored (e.g., as designated by the cloud selecting module 270). Similarly, parity blocks may also be encrypted using a set of keys 265 associated with the storage cloud on which the parity blocks will be stored. In one embodiment, encrypting module 280 encrypts the data blocks prior to the parity module 185 generating the parity block. In such an embodiment, parity blocks may or may not be encrypted. Alternatively, the parity module 285 may generate parity blocks before the data blocks are encrypted. In one embodiment, the encrypting module 280 caches the security keys 265 in an ephemeral storage (e.g., volatile memory) such that if the storage appliance is powered off, it has to re-authenticate to obtain the keys 265.

Arranging storage clouds into a RAIC can provide increased security over storing data to a single storage cloud. Without the use of a RAIC, a third party can gain access to all data stored in the storage cloud by obtaining a single set of keys. However, typically a different set of keys are used for each storage cloud account. Therefore, for a RAIC using a RAID mode that performs striping (e.g., RAID 0, RAID 3, RAID 5, etc.), a third party needs to obtain multiple sets of keys to gain access to all the data stored in the storage clouds. Depending on how data is divided into data blocks, by obtaining a single set of keys a third party may gain access to a portion of data stored in the compromised storage cloud. However, if data is divided between the data blocks at the bit or byte level (e.g., a first bit is assigned to a first data block, a second bit is assigned to a second data block, a third bit is assigned to the first data block, a fourth bit is assigned to the fourth data block, and so on), a single data block may be unreadable without obtaining the remaining data blocks. Thus, a third party may have to acquire all of the sets of keys (or one less than all of the sets of keys if parity blocks are generated) to gain access to data stored in the storage clouds.

Cloud storage interaction module 290 generates messages directed to each of the storage clouds on which data blocks and/or parity blocks will be stored. Cloud storage module 290 may format each message in a format prescribed by the cloud storage service provider for the storage cloud to which the message will be sent. This may include adding an object name, pointer, length, checksum, etc. to a header of the message. A data block and/or storage block may be included in a body of the message. Cloud storage interaction module 290 then sends the messages to the appropriate storage clouds.

Occasionally a storage cloud may become temporarily unavailable, may crash, or may lose data. When a storage cloud (or multiple storage clouds) becomes temporarily unavailable, RCSM 255 continues to store data in those storage clouds in a RAIC configuration that are still available. Data blocks and/or parity blocks that should have been stored on the temporarily unavailable storage cloud are written to a cloud cache 260. Once the unavailable storage cloud again becomes available (e.g., comes online), cloud recovery module 295 resynchronizes that storage cloud with the rest of the storage clouds in a RAIC configuration by writing the data blocks and storage blocks in the cloud cache 260 to that storage cloud. Unlike standard RAID arrays of disk drives, synchronization of a storage cloud that temporarily became unavailable does not require all the data on the storage cloud to be rebuilt from scratch.

Note that though the preceding and following description discusses RAICs that are configured using multiple different storage clouds, RAICs may also be set up using different cloud accounts with a single storage cloud. All of the techniques discussed herein may apply equally well to multiple cloud accounts with a single or a few storage clouds. For example, a RAIC may be configured such that data is stored across a first account and second account with Amazon's S3 storage cloud service. Each cloud account would typically be associated with a different set of encryption keys. In this example, for a third party to gain access to all data stored in the storage cloud, the third party would need to obtain the encryption keys associated with each cloud account. Therefore, a RAIC that includes multiple accounts with a single storage cloud may provide increased security over use of a single account with that storage cloud.

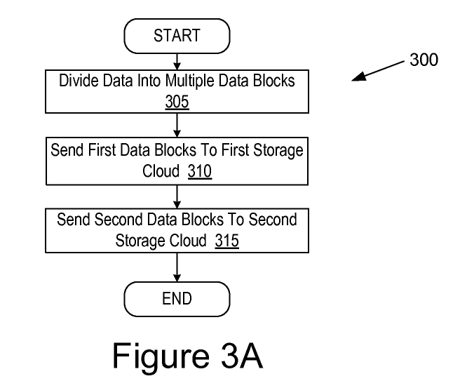

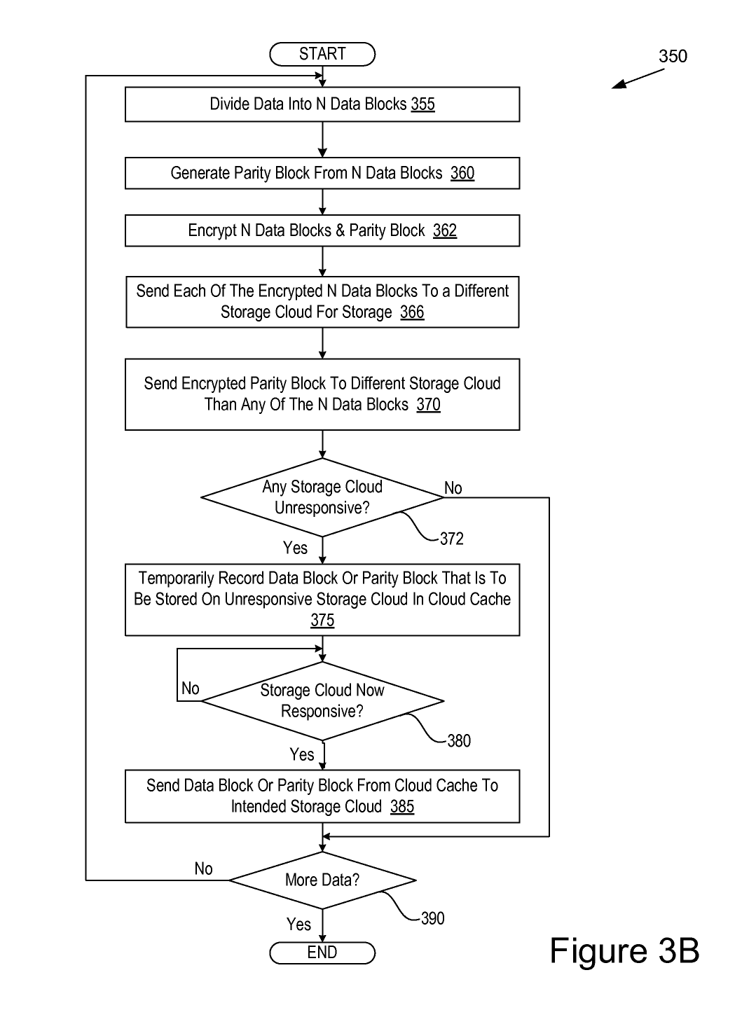

FIG. 3A is a flow diagram illustrating one embodiment of a method 300 for storing data in a redundant array of independent clouds. Method 300 may be performed when a RAID mode using striping (e.g., RAID 0 mode) is used. Method 300 may be performed by processing logic that may comprise hardware (circuitry, dedicated logic, etc.), software (such as is run on a general purpose computer system or a dedicated machine), or a combination of both. In one embodiment, method 300 is performed by a storage appliance, such as storage appliance 110 of FIG. 1. Method 300 may be performed, for example, by a reliable cloud storage module (e.g., RCSM 255) of a storage appliance or other computing device. Note that though method 300 is discussed as being performed by a storage appliance, method 300 may equally be performed by a server computer or client computer executing a reliable cloud storage module (e.g., RCSM 255 of FIG. 2).

At block 305 of method 300 a storage appliance divides data into multiple data blocks. The data may be a file, a group of files, a compressed data object, or other data. The data may be divided into the data blocks using a deterministic approach that can later be reversed to reconstruct the data. In one embodiment, the data is divided into chunks that are smaller than a size of the data blocks. These chunks can then be assigned to the data blocks in a round robin fashion. Alternatively, the data may be divided into chunks that are the size of the data blocks, and each data block may be assigned a single chunk.

Each data block is assigned to a specific storage cloud (or to a specific account with a storage cloud). Assignment may be performed in a round robin fashion until all data blocks have been assigned to a storage cloud. At block 310, first data blocks are sent to a first storage cloud for storage. At block 315, second data blocks are sent to a second storage cloud for storage. If there are more than two storage clouds included in the RAIC, additional data blocks may be sent to those other storage clouds for storage. Alternatively, if different accounts with a single storage cloud are used, at block 310 the first data blocks sent to a storage cloud for storage in a first account with the storage cloud, and at block 315 the second data blocks are sent to the same storage cloud for storage in a second account with the storage cloud. Note that each data block may be encrypted before it is sent to a storage cloud. Note also that the order in which data blocks are sent to or stored in the storage clouds is immaterial.

FIG. 3B is a flow diagram illustrating another embodiment of a method 350 for storing data in a redundant array of independent clouds. Method 350 may be performed when a RAID mode using both striping and error checking (e.g., RAID 3 mode, RAID 5 mode, etc.) is used. Method 350 may be performed by processing logic that may comprise hardware (circuitry, dedicated logic, etc.), software (such as is run on a general purpose computer system or a dedicated machine), or a combination of both. In one embodiment, method 350 is performed by a storage appliance, such as storage appliance 110 of FIG. 1. Method 350 may be performed, for example, by a reliable cloud storage module (e.g., RCSM 255) of a storage appliance or other computing device. Note that though method 350 is discussed as being performed by a storage appliance, method 350 may equally be performed by a server computer or client computer executing a reliable cloud storage module (e.g., RCSM 255 of FIG. 2).

At block 355 of method 350 a storage appliance divides data into multiple data blocks. At block 360, the storage appliance generates a parity block from the data blocks. In one embodiment, the parity block is generated by performing a Boolean XOR operation between the data blocks.

At block 362, the storage appliance encrypts the multiple data blocks and the parity block. Each of the data blocks and the parity block may be encrypted using a different set of encryption keys that are associated with an account on a particular storage cloud. If the same set of encryption keys are used for multiple storage clouds (or storage cloud accounts), then some or all data blocks and/or the parity block may be encrypted using the same set of encryption keys.

At block 366, the storage appliance ends each of the encrypted data blocks to a different storage cloud for storage. At block 370, the storage appliance sends the encrypted parity block to a different storage cloud than any of the data blocks for storage.

At block 372, the storage appliance determines whether any of the storage clouds are unresponsive. If a storage cloud is unresponsive, then a data block or parity block may not have been successfully sent to that storage cloud. Accordingly, if a storage cloud is unresponsive, the method proceeds to block 375. Otherwise, the method continues to block 390.

At block 375, the storage appliance temporarily records the data block or parity block that was supposed to be stored on the unresponsive storage cloud. The data block or parity block may be stored in a cloud cache that is maintained by the storage appliance. At block 380, the storage appliance determines whether the storage cloud is still unresponsive. If the storage cloud is not yet responsive, the method repeats block 380. Once the storage cloud becomes responsive, the method proceeds to block 385. At block 385, the storage appliance sends the data block or parity block from the cloud cache to the intended storage cloud for storage. This resynchronizes that storage cloud with the other storage clouds in the RAIC.

At block 390, the storage appliance determines whether there is additional data that needs to be stored on the RAIC. If there is additional data to store, the method returns to block 355. Otherwise the method ends.

Method 350 permits the storage appliance to continue to present the RAIC to clients as an available storage device without errors even when one or more storage clouds becomes temporarily unavailable. While a storage cloud is unavailable, all data blocks and parity blocks that should have been stored on that storage cloud are cached. Then, when the storage cloud comes back online, that storage cloud can be synchronized with the remaining storage clouds in the RAIC by sending the data blocks and parity blocks in the cache to that storage cloud. Thus, storage clouds do not need to be fully rebuilt, and can instead be partially rebuilt after being taken offline. If a client attempts to read data that has data blocks that are still in the cloud cache, the storage appliance may retrieve those data blocks from the cloud cache rather than from the unavailable storage cloud to which they have not yet been written.

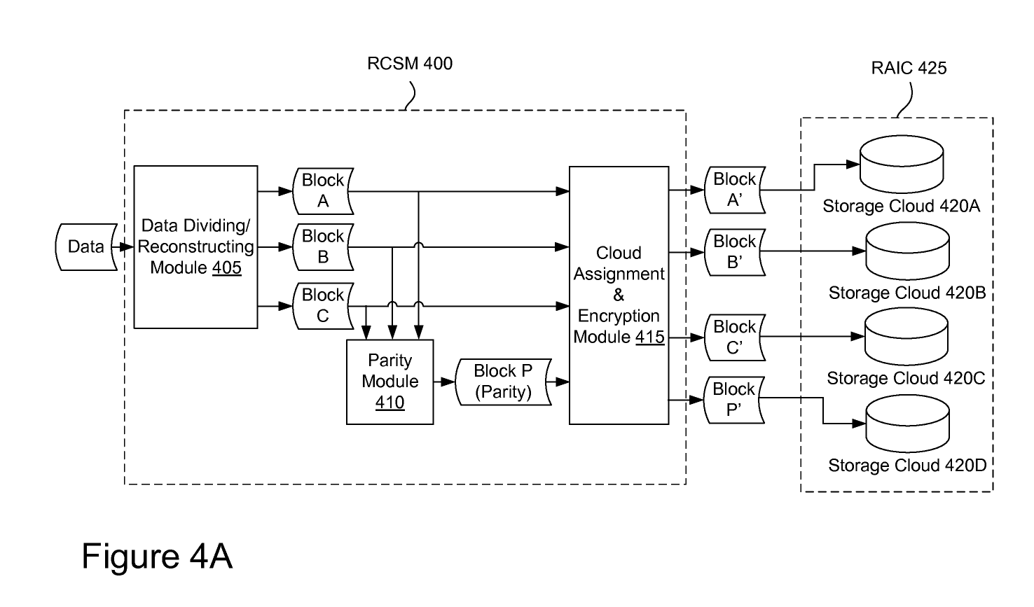

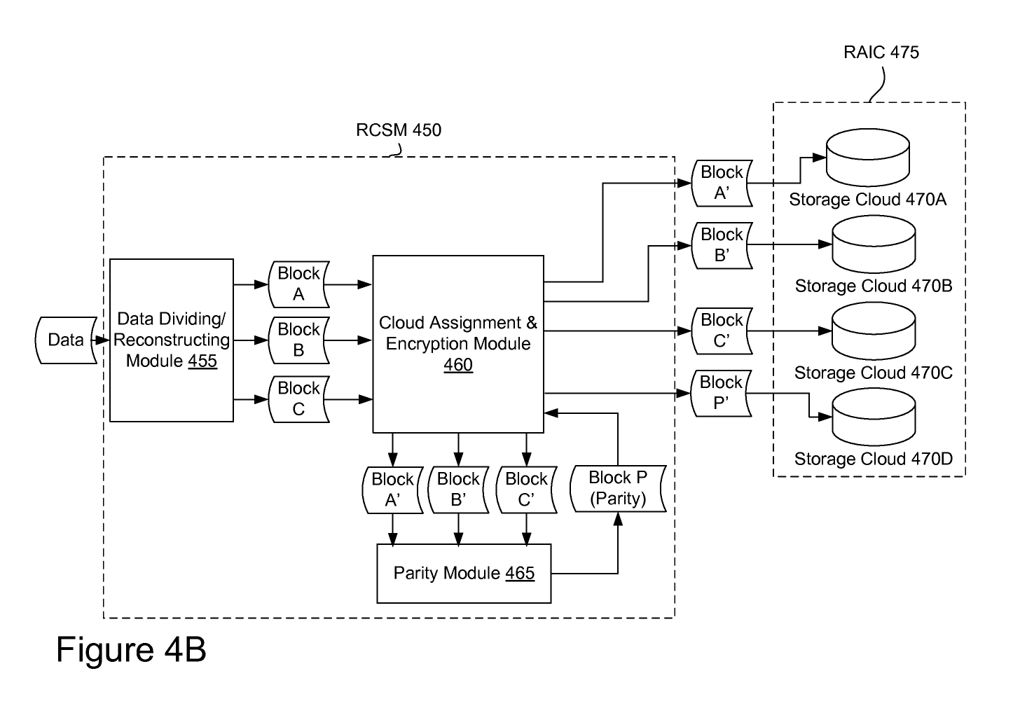

FIG. 4A is a block diagram illustrating one example of storing data in a redundant array of independent clouds 425 by a reliable cloud storage module 400, in accordance with one embodiment of the present invention. In the illustrated embodiment, the RCSM 400 includes a data dividing/reconstructing module 405, parity module 410 and cloud assignment and encryption module 415. Note that the cloud assignment and encryption module 415 may perform the functionality of each of the cloud selecting module 270, encrypting module 280 and cloud storage interaction module 290 of RCSM 255. Similarly, the data dividing/reconstructing module 405 may perform the functionality of each of the data dividing module 275 and data reconstructing module 280 of RCSM 255.

When the RCSM 400 receives data, the data is input into data dividing/reconstructing module 405. Data dividing/reconstructing module 405 divides the data into multiple data blocks (e.g., block A, block B and block C). These data blocks are sent both to parity module 410 and to cloud assignment and encryption module 415. Parity module 410 generates a parity block (block P) from the data blocks and forwards the parity block to cloud assignment and encryption module 415.

Cloud assignment and encryption module 415 selects a storage cloud 420A, 420B, 420C, 420D from the RAIC 425 on which to store each of the data blocks and the parity block. For each data block and parity block, cloud assignment and encryption module 415 encrypts the data block or parity block using an encryption key associated with the storage cloud to which that block will be stored. Encrypted data blocks (e.g., block A′, block B′ and block C′) and an encrypted parity block (block P′) are then each stored to a different storage cloud 420A, 420B, 420C, 420D.

FIG. 4B is a block diagram illustrating an example of storing data in a redundant array of independent clouds 475 by an RCSM 450, in accordance with another embodiment of the present invention. Referring to FIG. 4B, in the illustrated embodiment, the RCSM 450 includes a data dividing/reconstructing module 455, parity module 465 and cloud assignment and encryption module 460. Note that the cloud assignment and encryption module 460 may perform the functionality of each of the cloud selecting module 270, encrypting module 280 and cloud storage interaction module 290 of RCSM 255. Similarly, the data dividing/reconstructing module 455 may perform the functionality of each of the data dividing module 275 and data reconstructing module 298 of RCSM 255.

When the RCSM 450 receives data, the data is input into data dividing/reconstructing module 455. Data dividing/reconstructing module 455 divides the data into multiple data blocks (e.g., block A, block B and block C). These data blocks are sent to cloud assignment and encryption module 460. Cloud assignment and encryption module 460 selects a storage cloud 470A, 470B, 470C, 470D from the RAIC 475 on which to store each of the data blocks. For each data block, cloud assignment and encryption module 460 encrypts the data block using an encryption key associated with the storage cloud to which that block will be stored. Encrypted data blocks (e.g., block A′, block B′ and block C′) are then each stored to a different storage cloud 470A, 470B, 420C.

Cloud assignment and encryption module 460 forwards each of the encrypted data blocks (e.g., block A′, block B′ and block C′) to parity module 465. Parity module 465 generates a parity block (block P) from the data blocks and returns the parity block to cloud assignment and encryption module 460. In one embodiment, cloud assignment and encryption module 460 then encrypts the parity block using an encryption key associated with storage cloud 470D, and then stores the encrypted parity block (block P′) on that storage cloud 470D. In an alternative embodiment, cloud assignment and encryption module 460 stores the parity block on storage cloud 470D without first encrypting the parity block.

Referring back to FIG. 2, after data has been divided into numerous data blocks and stored in different storage clouds, those data blocks may later be recombined to reconstruct the data. While a storage cloud in the RAIC is unavailable (either temporarily or permanently), or if data from a storage cloud is lost or corrupted, a client can continue to read data in the RAIC. In one embodiment, RCSM 255 includes data reconstructing module 298, which combines data blocks and/or parity blocks to reconstruct data. When the reliable cloud storage module 255 receives a request to read data from a client, data reconstructing module 298 determines which data blocks are necessary to reconstruct the data. Cloud storage interaction module 290 retrieves these data blocks from the storage clouds and provides them to encrypting module 280. Encrypting module decrypts the data blocks using encryption keys associated with the storage clouds on which the data blocks were stored. Encrypting module 280 then forwards cleartext (unencrypted) data blocks to data reconstructing module 298. Data reconstructing module 298 reconstructs the data from the data blocks, after which RCSM 255 may provide the data to the client.

Occasionally, clients may request to read data that has been divided into one or more data blocks stored on a currently unavailable storage cloud. When this occurs, cloud storage interaction module 290 retrieves data blocks associated with the requested data from all available storage clouds. In addition, cloud storage interaction module 290 retrieves one or more parity blocks associated with the data from the available storage clouds. Cloud storage interaction module 290 provides the data blocks and the parity blocks to parity module 285, which may reconstruct the missing data blocks from the retrieved data blocks and the parity blocks. The encrypting module 280 decrypts the data blocks. The data reconstructing module 298 then reconstructs the data from the unencrypted data blocks. Note that if the parity blocks were generated from unencrypted data blocks, the retrieved data blocks may be decrypted before reconstructing the missing data blocks. Additionally, the parity blocks may also be decrypted before reconstructing the missing data blocks.

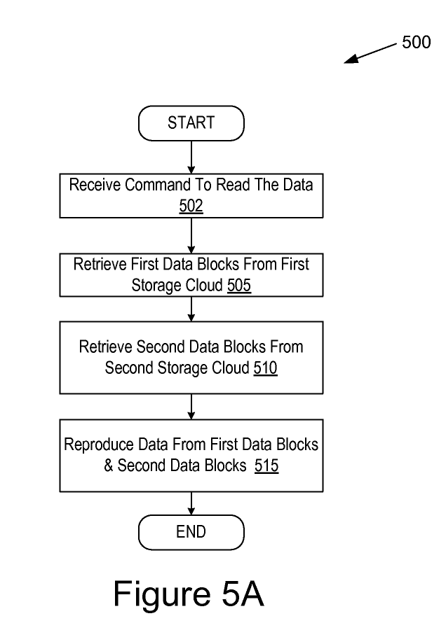

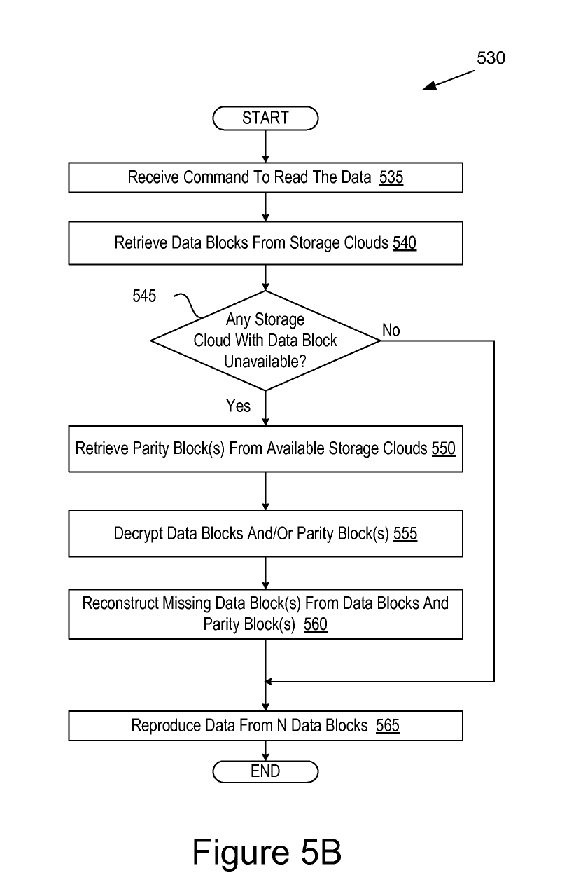

FIG. 5A is a flow diagram illustrating one embodiment of a method 500 for retrieving data from a redundant array of independent clouds. Method 500 may be performed by processing logic that may comprise hardware (circuitry, dedicated logic, etc.), software (such as is run on a general purpose computer system or a dedicated machine), or a combination of both. In one embodiment, method 500 is performed by a storage appliance, such as storage appliance 110 of FIG. 1. Method 500 may be performed, for example, by a reliable cloud storage module (e.g., RCSM 255) of a storage appliance or other computing device. Note that though method 500 is discussed as being performed by a storage appliance, method 500 may equally be performed by a server computer or client computer executing a reliable cloud storage module (e.g., RCSM 255 of FIG. 2).

At block 502 of method 500, a storage appliance receives a command to read data. At block 505, the storage appliance retrieves first data blocks for a first storage cloud. At block 510, the storage appliance retrieves second data blocks from a second storage cloud. At block 515, the storage appliance reproduces the data by recombining the first data blocks and the second the blocks. The reproduced data may then be provided to a client from which the request was received.

FIG. 5B is a flow diagram illustrating another embodiment of a method 530 for retrieving data from a redundant array of independent clouds. Method 530 may be performed by processing logic that may comprise hardware (circuitry, dedicated logic, etc.), software (such as is run on a general purpose computer system or a dedicated machine), or a combination of both. In one embodiment, method 530 is performed by a storage appliance, such as storage appliance 110 of FIG. 1. Method 530 may be performed, for example, by a reliable cloud storage module (e.g., RCSM 255) of a storage appliance or other computing device. Note that though method 530 is discussed as being performed by a storage appliance, method 530 may equally be performed by a server computer or client computer executing a reliable cloud storage module (e.g., RCSM 255 of FIG. 2).

At block 535 of method 530, a storage appliance receives a command to read data. At block 540, the storage appliance determines what data blocks are associated with the requested data, and attempts to retrieve those data blocks from the storage clouds in the RAIC.

At block 545, the storage appliance determines whether any storage clouds storing data blocks associated with the requested data are unavailable. If any storage cloud that has necessary data blocks is unavailable, the method proceeds to block 550. Otherwise, the method proceeds to block 565.

At block 550, the storage appliance retrieves one or more parity blocks associated with the requested data from the available storage clouds. At block 555, the storage appliance decrypts the data blocks. The storage appliance may also decrypt the parity block (or blocks) if they have been encrypted. At block 560, the storage appliance reconstructs the missing data blocks from the obtained data blocks and the obtained parity block (or parity blocks). Note that in some embodiments the operations of block 560 and block 555 may be reversed such that the missing data blocks are reconstructed before performing decryption.

At block 565, the storage appliance reproduces the data by recombining retrieved data blocks and the reconstructed data blocks. The reproduced data may then be provided to a client from which the request was received.

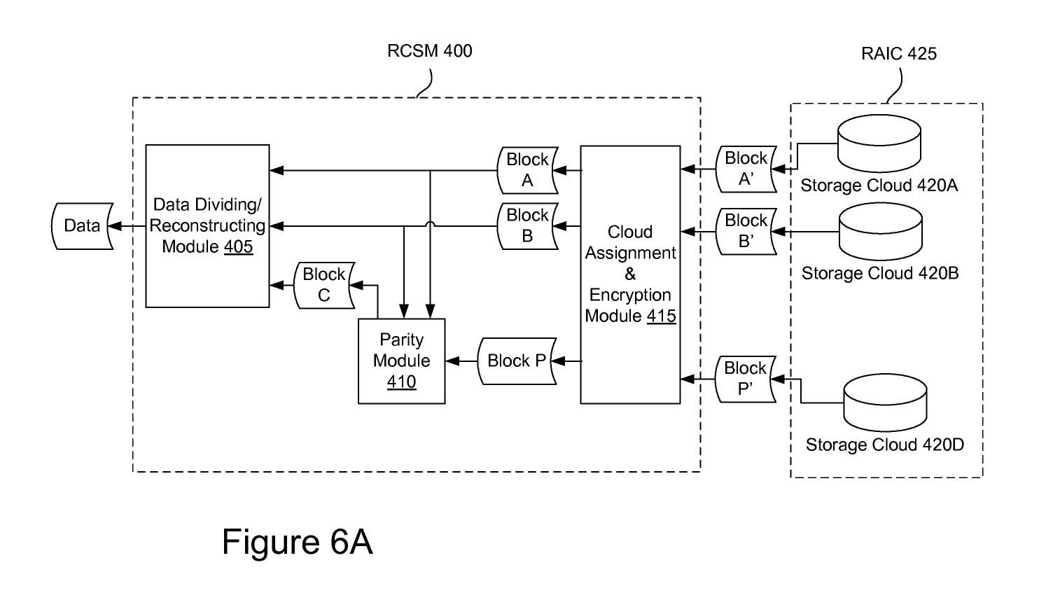

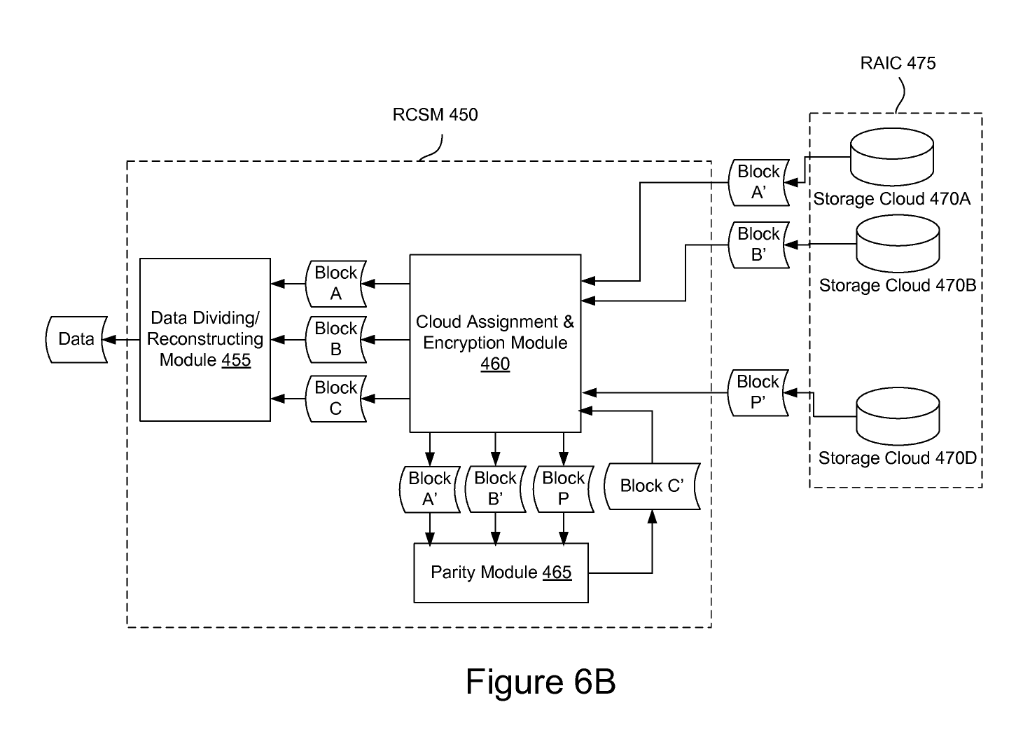

FIG. 6A is a block diagram illustrating one example of retrieving data from a redundant array of independent clouds 425 by an RCSM 400 when a storage cloud is unavailable, in accordance with one embodiment of the present invention. The RCSM 400 and RAIC 425 correspond to those illustrated in FIG. 4A.

To reconstruct data stored in the RAIC 425 when a storage cloud is unavailable, RCSM 400 retrieves encrypted data blocks (e.g., block A′ and block B′) from storage clouds 420A and 420B and retrieves an encrypted parity block (block P′) from storage cloud 420D. Cloud assignment and encryption module 415 decrypts the encrypted data blocks and encrypted parity block using encryption keys associated with the storage clouds on which each individual data block/parity block was stored. The unencrypted data blocks (block A and block B) are forwarded to data dividing/reconstructing module 405 and to parity module 410. The unencrypted parity block (block P) is forwarded to parity module 410. The missing data block (block C) is reconstructed from the retrieved data blocks and parity block and forwarded to data dividing/reconstructing module 405, which reconstructs the data from the data blocks. The reconstructed data may then be provided to a client.

FIG. 6B is a block diagram illustrating one embodiment of retrieving data from a redundant array of independent clouds 475 by an RCSM 450 when a storage cloud is unavailable, in accordance with another embodiment of the present invention. The RCSM 450 and RAIC 475 correspond to those illustrated in FIG. 4B.

To reconstruct data stored in the RAIC 475 when a storage cloud is unavailable, RCSM 450 retrieves encrypted data blocks (e.g., block A′ and block B′) from storage clouds 470A and 470B and retrieves an encrypted parity block (block P′) from storage cloud 470D. Cloud assignment and encryption module 460 decrypts the encrypted parity block using an encryption key associated with storage cloud 470D. The unencrypted parity block (block P) and encrypted data blocks (block A′ and block B′) are forwarded to parity module 465. The missing encrypted data block (block C′) is reconstructed from the retrieved encrypted data blocks (block A′ and block B′) and parity block (block P) and returned to cloud assignment and encryption module 460.

Cloud assignment and encryption module 460 decrypts each of the encrypted data blocks (block A′, block B′, block C′), and provides unencrypted data blocks (block A, block B, block C) to data dividing/reconstructing module 455. Data dividing/reconstructing module 455 reconstructs the data from the data blocks, and may then provide the data to a client.

Returning to FIG. 2, when a storage cloud fails completely, or otherwise loses data, the data from that storage cloud may be rebuilt and copied to an alternative storage cloud. This may be performed by reading back data from all other storage clouds in the RAIC, performing an XOR operation from the retrieved data (including data blocks and parity blocks), and writing the result to the alternative storage cloud.

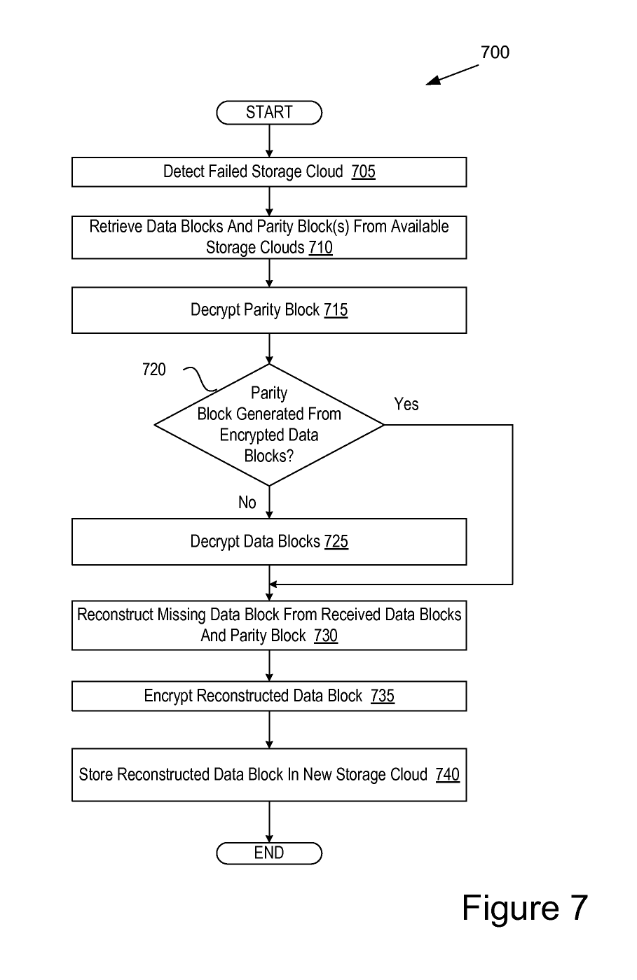

FIG. 7 is a flow diagram illustrating one embodiment of a method 700 for rebuilding data from a failed storage cloud. Method 700 may be performed by processing logic that may comprise hardware (circuitry, dedicated logic, etc.), software (such as is run on a general purpose computer system or a dedicated machine), or a combination of both. In one embodiment, method 700 is performed by a storage appliance, such as storage appliance 110 of FIG. 1. Method 700 may be performed, for example, by a reliable cloud storage module (e.g., RCSM 255) of a storage appliance or other computing device. Note that though method 700 is discussed as being performed by a storage appliance, method 700 may equally be performed by a server computer or client computer executing a reliable cloud storage module (e.g., RCSM 255 of FIG. 2).

At block 705 of method 700, a storage appliance detects a failed storage cloud. At block 710, the storage appliance retrieves data blocks and one or more parity blocks from the available storage clouds (all but the failed storage cloud). If the parity block (or blocks) is encrypted, then at block 715, the parity block is decrypted.

At block 720, the storage appliance determines whether the parity block (or blocks) was generated from encrypted data blocks. If the parity block was not generated from encrypted data blocks, the method continues to block 725 and the retrieved data blocks are decrypted before continuing to block 730. If the parity block was generated from encrypted data blocks, the method proceeds directly to block 730 from block 720.

At block 730, the storage appliance reconstructs the missing data block from the received data blocks and the parity block (or parity blocks). At block 735 the storage appliance encrypts the reconstructed data block. The storage appliance may encrypt the reconstructed data block using an encryption key associated with a new storage cloud on which the reconstructed data block will be stored. At block 740, the storage appliance sends the reconstructed data block to the new storage cloud for storage. The method then ends.

Note that when a storage cloud fails, data blocks (and possibly parity blocks) that were stored on the failed storage cloud may be reconstructed and written to a new storage cloud in a piecewise fashion. It may be inefficient to completely reconstruct all the data from the failed storage cloud at once. Therefore, in one embodiment, data blocks and parity blocks from the failed storage cloud are reconstructed and stored to the new storage cloud only when a client has requested to read data that included data blocks or parity blocks that had been stored on the failed storage cloud. In this instance, the available data blocks and/or parity blocks have already been retrieved to perform a read operation, and likely the missing data blocks have already been reconstructed to satisfy the read operation. Thus, the only additional overhead associated with rebuilding the data onto the new storage cloud is an additional write operation to the new storage cloud.

Note that until all data blocks and parity blocks that were stored on a failed storage cloud have been recovered and written to a new storage cloud, the encryption keys associated with the failed storage cloud should be kept. Without these encryption keys, reconstructed data blocks may be indecipherable.

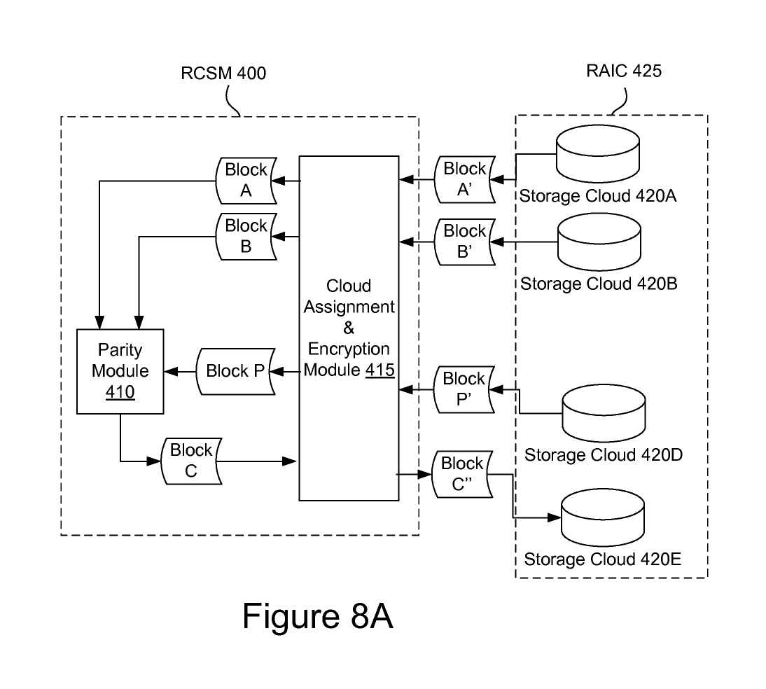

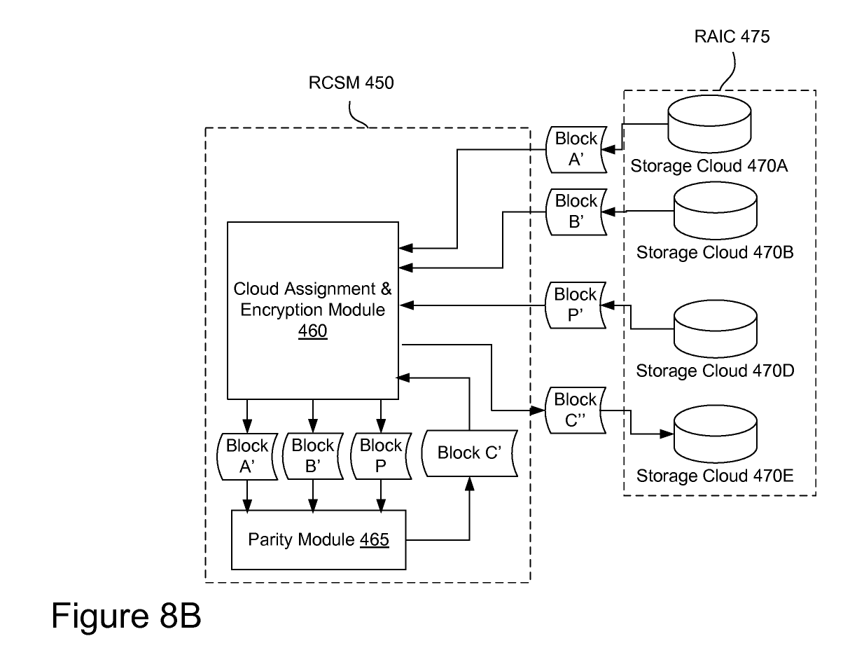

FIG. 8A is a block diagram illustrating an example of reconstructing data stored on a failed storage cloud in a RAIC 425 by an RCSM 400, in accordance with one embodiment of the present invention. The RCSM 400 and RAIC 425 correspond to those illustrated in FIG. 4A.

For RCSM 400 to reconstruct data from a failed storage cloud, cloud assignment and encryption module 415 retrieves encrypted data blocks (block A′ and block B′) and an encrypted parity block (block P′) from the available storage clouds 420A, 420B, 420D in the RAIC 425. Cloud assignment and encryption module 415 decrypts the encrypted data blocks and parity block, and provides the unencrypted data blocks (block A and block B) and unencrypted parity block (block P) to parity module 410. Parity module 410 reconstructs the missing data block, and forwards it back to cloud assignment and encryption module 415. Cloud assignment and encryption module 415 then encrypts the reconstructed data block (block C) using an encryption key associated with a new storage cloud 420E that has been added to the RAIC 425. The encrypted data block (block C″) is then stored on the new storage cloud 420E.

FIG. 8B is a block diagram illustrating an example of reconstructing data stored on a failed storage cloud in a RAIC 475 by an RCSM 450, in accordance with another embodiment of the present invention. The RCSM 450 and RAIC 475 correspond to those illustrated in FIG. 4B.

For RCSM 450 to reconstruct data from a failed storage cloud, cloud assignment and encryption module 460 retrieves encrypted data blocks (block A′ and block B′) and an encrypted parity block (block P′) from the available storage clouds 420A, 420B, 420D in the RAIC 425. Cloud assignment and encryption module 460 decrypts the encrypted parity block, and provides the encrypted data blocks (block A′ and block B′) and unencrypted parity block (block P) to parity module 465. Parity module 465 reconstructs the missing encrypted data block (block C′), and forwards it back to cloud assignment and encryption module 460. Cloud assignment and encryption module 560 then encrypts the reconstructed data block (block C′) using an encryption key associated with a new storage cloud 470E that has been added to the RAIC 475. The encrypted data block (block C″) is then stored on the new storage cloud 420E. In one embodiment, cloud assignment and encryption module 460 decrypts encrypted block C′ before re-encrypting it using a different key to create encrypted block C″. Note that in the illustrated example, it is unnecessary for cloud assignment and encryption module 460 to decrypt the encrypted data blocks to reconstruct the missing data block.

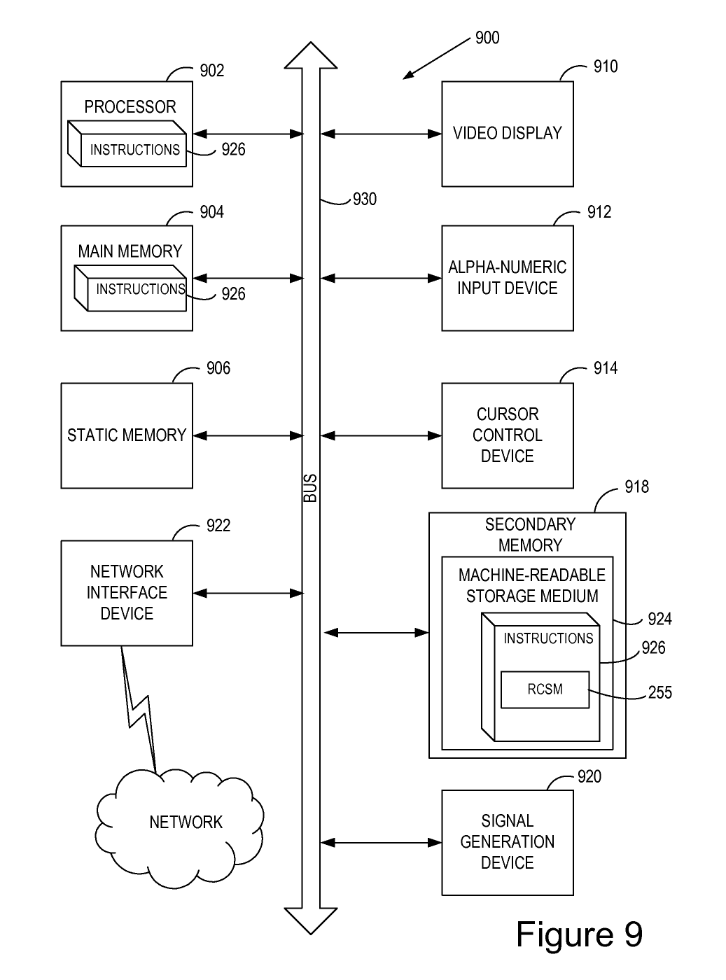

FIG. 9 illustrates a diagrammatic representation of a machine in the exemplary form of a computer system 900 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 900 includes a processor 902, a main memory 904 (e.g., read-only memory (ROM), flash memory, dynamic random access memory (DRAM) such as synchronous DRAM (SDRAM) or Rambus DRAM (RDRAM), etc.), a static memory 906 (e.g., flash memory, static random access memory (SRAM), etc.), and a secondary memory 918 (e.g., a data storage device), which communicate with each other via a bus 930.

Processor 902 represents one or more general-purpose processing devices such as a microprocessor, central processing unit, or the like. More particularly, the processor 902 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 902 may also be one or more special-purpose processing devices such as an application specific integrated circuit (ASIC), a field programmable gate array (FPGA), a digital signal processor (DSP), network processor, or the like. Processor 902 is configured to execute instructions 926 (e.g., processing logic) for performing the operations and steps discussed herein.

The computer system 900 may further include a network interface device 922. The computer system 900 also may include a video display unit 910 (e.g., a liquid crystal display (LCD) or a cathode ray tube (CRT)), an alphanumeric input device 912 (e.g., a keyboard), a cursor control device 914 (e.g., a mouse), and a signal generation device 920 (e.g., a speaker).

The secondary memory 918 may include a machine-readable storage medium (also known as a computer-readable storage medium) 924 on which is stored one or more sets of instructions 926 (e.g., software) embodying any one or more of the methodologies or functions described herein. The instructions 926 may also reside, completely or at least partially, within the main memory 904 and/or within the processor 902 during execution thereof by the computer system 900, the main memory 904 and the processor 902 also constituting machine-readable storage media.

The machine-readable storage medium 924 may also be used to store the reliable cloud storage module 255 of FIG. 2 and/or a software library containing methods that call the RCSM 200. While the machine-readable storage medium 924 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present invention. The term “machine-readable storage medium” shall accordingly be taken to include, but not be limited to, solid-state memories, and optical and magnetic media.

Some portions of the detailed description are presented in terms of methods. These methods may be performed by processing logic that may comprise hardware (circuitry, dedicated logic, etc.), software (such as is run on a general purpose computer system or a dedicated machine), or a combination of both. In certain embodiments, the methods are performed by a storage appliance, such as storage appliance 110 of FIG. 1. Some methods may be performed by a reliable cloud storage module (e.g., RCSM 255) of a storage appliance or other computing device. Note that though some of the above described methods are discussed as being performed by a storage appliance, these methods may equally be performed by a server computer or client computer executing a reliable cloud storage module (e.g., RCSM 255 of FIG. 2).

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A method, comprising:
dividing data into a first data block and a second data block by a computing device executing a reliable cloud storage module;
sending the first data block to a first storage cloud provided by a first storage service;
sending the second data block to a second storage cloud provided by a second storage service;
receiving a request to read the data by the computing device;
retrieving the first data block from the first storage cloud and the second data block from the second storage cloud; and
reproducing the data from the first data block and the second data block.

2. The method of claim 1, further comprising:
generating a parity block from the first data block and the second data block; and
sending the parity block to a third storage cloud.

3. The method of claim 2, further comprising:
encrypting the first data block using a first encryption key associated with the first storage cloud; and
encrypting the second data block using a second encryption key associated with the second storage cloud.

4. The method of claim 3, wherein the parity block is generated from the first data block and the second data block after the first data block and the second data block have been encrypted.

5. The method of claim 3, wherein the parity block is generated from the first data block and the second data block before the first data block and the second data block have been encrypted, the method further comprising:
encrypting the parity block using a third encryption key associated with the third storage cloud.

6. The method of claim 3, further comprising:
receiving the request to read the data while the first storage cloud is unresponsive;
retrieving the second data block from the second storage cloud and the parity block from the third storage cloud; and
rebuilding the first data block from the second data block and the parity block.

7. The method of claim 2, further comprising:
detecting that one of the first storage cloud, the second storage cloud or the third storage cloud has become unresponsive;
temporarily caching the first data block, the second data block or the parity block that is to be sent to the unresponsive storage cloud; and
upon establishing a connection to the unresponsive storage cloud, synchronizing contents of the unresponsive storage cloud to contents of the remaining storage clouds by sending the first data block, the second data block or the parity block to the unresponsive storage cloud.

8. The method of claim 1, further comprising:
sending the first data block to a third storage cloud provided by a third storage service, wherein the third storage cloud mirrors the first storage cloud; and
sending the second data block to a fourth storage cloud provided by a fourth storage service, wherein the fourth storage cloud mirrors the second storage cloud.

9. A computer readable storage medium including instructions that, when executed by a processing device, cause the processing device to perform a method, comprising:
dividing data into a first data block and a second data block by the computing device;
sending the first data block to a first storage cloud provided by a first storage service;
sending the second data block to a second storage cloud provided by a second storage service;
receiving a request to read the data;
retrieving the first data block from the first storage cloud and the second data block from the second storage cloud; and
reproducing the data from the first data block and the second data block.

10. The computer readable storage medium of claim 9, the method further comprising:
generating a parity block from the first data block and the second data block; and
sending the parity block to a third storage cloud.

11. The computer readable storage medium of claim 10, the method further comprising:
encrypting the first data block using a first encryption key associated with the first storage cloud; and
encrypting the second data block using a second encryption key associated with the second storage cloud.

12. The computer readable storage medium of claim 11, wherein the parity block is generated from the first data block and the second data block after the first data block and the second data block have been encrypted.

13. The computer readable storage medium of claim 11, wherein the parity block is generated from the first data block and the second data block before the first data block and the second data block have been encrypted, the method further comprising:
encrypting the parity block using a third encryption key associated with the third storage cloud.

14. The computer readable storage medium of claim 11, the method further comprising:
receiving the request to read the data while the first storage cloud is unresponsive;
retrieving the second data block from the second storage cloud and the parity block from the third storage cloud; and
rebuilding the first data block from the second data block and the parity block.

15. The computer readable storage medium of claim 10, the method further comprising:
detecting that one of the first storage cloud, the second storage cloud or the third storage cloud has become unresponsive;
temporarily caching the first data block, the second data block or the parity block that is to be sent to the unresponsive storage cloud; and
upon establishing a connection to the unresponsive storage cloud, synchronizing contents of the unresponsive storage cloud to contents of the remaining storage clouds by sending the first data block, the second data block or the parity block to the unresponsive storage cloud.

16. The computer readable medium of claim 9, the method further comprising:
sending the first data block to a third storage cloud provided by a third storage service, wherein the third storage cloud mirrors the first storage cloud; and
sending the second data block to a fourth storage cloud provided by a fourth storage service, wherein the fourth storage cloud mirrors the second storage cloud.

17. A storage appliance, comprising:
a memory to store instructions for a reliable cloud storage module; and
a processing device, connected with the memory, to execute the instructions, wherein the instructions cause the processing device to:
divide data into a first data block and a second data block;
send the first data block to a first storage cloud provided by a first storage service;
send the second data block to a second storage cloud provided by a second storage service;
retrieve the first data block from the first storage cloud and the second data block from the second storage cloud upon receipt of a request to read the data; and
reproduce the data from the first data block and the second data block.

18. The storage appliance of claim 17, further comprising the instructions to cause the processing device to:
generate a parity block from the first data block and the second data block; and
send the parity block to a third storage cloud.

19. The storage appliance of claim 18, further comprising the instructions to cause the processing device to:
encrypt the first data block using a first encryption key associated with the first storage cloud; and
encrypt the second data block using a second encryption key associated with the second storage cloud.

20. The storage appliance of claim 19, wherein the parity block is generated from the first data block and the second data block after the first data block and the second data block have been encrypted.

21. The storage appliance of claim 19, wherein the parity block is generated from the first data block and the second data block before the first data block and the second data block have been encrypted, the instructions further to cause the processing device to:
encrypt the parity block using a third encryption key associated with the third storage cloud.

22. The storage appliance of claim 19, the instructions further to cause the processing device to:
receive the request to read the data while the first storage cloud is unresponsive;
retrieve the second data block from the second storage cloud and the parity block from the third storage cloud; and
rebuild the first data block from the second data block and the parity block.

23. The storage appliance of claim 18, the instructions further to cause the processing device to:
detect that one of the first storage cloud, the second storage cloud or the third storage cloud has become unresponsive;
temporarily cache the first data block, the second data block or the parity block that is to be sent to the unresponsive storage cloud; and
upon establishing a connection to the unresponsive storage cloud, synchronize contents of the unresponsive storage cloud to contents of the remaining storage clouds by sending the first data block, the second data block or the parity block to the unresponsive storage cloud.

24. The storage appliance of claim 18, further comprising the instructions to cause the processing device to:
send the first data block to a third storage cloud provided by a third storage service, wherein the third storage cloud mirrors the first storage cloud; and
send the second data block to a fourth storage cloud provided by a fourth storage service, wherein the fourth storage cloud mirrors the second storage cloud.
